(19) United States
(12) Patent Application Publication
(10) Pub. No.: US 2009/0289785 A1
(43) Pub. Date: Nov. 26, 2009

(54) GPS Tracking System for Individuals, Pets or Possessions

(76) Inventor: Ellen Leonard, Ossining, NY (US)

Correspondence Address: Ellen M. Leonard, 13 Murray Lane, Ossining, NY, 10562, US

(21) Appl. No.: 12/338,414

(22) Filed: Dec. 18, 2008

Related U.S. Application Data
(60) Provisional application No. 61/006,093, filed on Dec. 19, 2007.

(51) Int. Cl. G08B 1/08

(52) U.S. Cl. 340/539.13

(57) ABSTRACT

A tracking system for individuals, pets or possessions includes a GPS transmitter that sends a tracking signal. The GPS transmitter includes a button for activation. An adhesive patch adhesively attaches to a body surface. A means for attaching about a body part is included. A GPS receiver includes a map display. A speaker emits alert tones and verbal announcements. A receiver receives the tracking signal from the GPS transmitter and alerts a user with an alert tone identifying the GPS transmitter. An icon identifies the GPS transmitter and is superimposed on a map image to indicate the location of the GPS transmitter. A name, associated with the icon, displays on the map display. A means produces verbal announcements on the speaker. A means presents available information regarding a mode of transportation. An activation button activates the receiver to receive the tracking signal without requiring the activation of the transmitter.

### CROSS-REFERENCE TO RELATED APPLICATIONS

The present Utility patent application claims priority benefit of the U.S. provisional application for patent Ser. No. 61/006093 filed on Dec. 19, 2007 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to Global Positioning System (GPS) tracking. More particularly, the invention relates to a two part tracking system comprising a transmitter and a GPS receiver/monitor.

### BACKGROUND OF THE INVENTION

Having means to locate a child can help prevent child abduction or the child getting lost. Also, the ability to pinpoint a location would be helpful for persons caring for elderly or compromised adults who may wander off and become disoriented and lost. Furthermore, lost pets are often never found, and many pet owners would like means for locating their pets if lost.

There are known solutions for tracking and locating people and animals. However, many of these solutions do not become active unless the person or animal being tracked leaves specified boundaries. Also, the coverage range of many of these solutions is limited. Furthermore, some currently known solutions require the tracker to contact a command center or to look at a website for location information rather than taking immediate action, which can waste valuable time. Currently known solutions also often utilize activation devices or transmitters that are easily detectable and removable. This enables a predator to remove the device, rendering the system virtually useless.

In view of the foregoing, there is a need for improved techniques for locating people or animals that may be activated anywhere and at anytime, has a wide range of coverage, enables a user to take immediate action, and has an inconspicuous transmitter.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1E illustrate exemplary transmitters for a GPS tracking system for locating people or animals, in accordance with embodiments of the present invention. FIG. 1A shows adhesive patches; FIG. 1B shows an adhesive strap transmitter; FIG. 1C shows jewelry transmitters; FIG. 1D shows adhesive patches for animals, and FIG. 1E shows a collar transmitter; and

FIGS. 2A and 2B illustrate an exemplary GPS receiver/monitor for a GPS tracking system for locating people or animals, in accordance with an embodiment of the present invention. FIG. 2A is a front view where a map locator display screen is inactive, and FIG. 2B is a front view with the map locator display screen activated.

Unless otherwise indicated illustrations in the figures are not necessarily drawn to scale.

### SUMMARY OF THE INVENTION

To achieve the forgoing and other objects and in accordance with the purpose of the invention, a GPS tracking system for individuals, pets or possessions is presented.

In one embodiment, a tracking system for individuals, pets or possessions is presented. The system includes a GPS transmitter configurable for joining to individuals, pets or possessions. The GPS transmitter includes a transmitter for sending a tracking signal. When the GPS transmitter is configured for joining to individuals the transmitter includes a button for activation. When an individual is in need of assistance, the individual presses the button a plurality of times to activate the transmitter to send the tracking signal. When the GPS transmitter is configured for joining to pets the transmitter is configurable for automatic activation to send the tracking signal when the transmitter is moved outside of a desired bounded area. The tracking signal provides a continuously updated location of the transmitter. Means for joining to a body surface is included when the GPS transmitter is configured for joining to body surfaces of individuals or pets. The means for joining includes an adhesive patch joined to the transmitter for adhesively attaching to the body surface. When the GPS transmitter is configured for joining to body surfaces of individuals, the adhesive patch generally being attached to an inconspicuous location of the body surface to mitigate detection and unauthorized removal. When the GPS transmitter is configured for joining to body surfaces of pets, the adhesive patch includes a furry surface generally matching a color of a fur of a pet to which the adhesive patch is to be applied. The furry surface mitigates detection and unauthorized removal. Means for attaching about a body part when the GPS transmitter is configured for joining about body parts of individuals or pets is included. When the GPS transmitter is configured for joining about body parts of individuals, the means for attaching includes jewelry to which the transmitter is joined. When the GPS transmitter is configured for joining about body parts of pets the attaching means includes a collar where the transmitter is joined to an interior surface of the collar to avoid detection. A GPS receiver configurable for receiving the tracking signal from the GPS transmitter includes a housing for housing the GPS receiver. A map display contained within the housing at least displays a map image. A speaker contained within the housing emits alert tones and verbal announcements. A receiver receives the tracking signal from the GPS transmitter and alerts a user with a programmable alert tone individually identifying the GPS transmitter. A programmable icon for displays on the map display. The programmable icon individually identifies the GPS transmitter and is superimposed on the map image to indicate the location of the GPS transmitter. The map image and a position of the programmable icon on the map image is continuously updated using the tracking signal. A programmable name, associated with the programmable icon, displays on the map display to further identify the GPS transmitter. Means for producing verbal announcements on the speaker is included. The verbal announcements provide a plurality of verbal narratives associated with the location of the GPS transmitter. Means for presenting available information regarding a mode of transportation associated with the GPS transmitter is included. An activation button activates the receiver to receive the tracking signal without requiring the activation of the transmitter, whereby the user can clearly identify and locate the GPS transmitter.

In another embodiment a tracking system for individuals, pets or possessions is presented. The system includes a GPS transmitter configurable for joining to individuals, pets or possessions. The GPS transmitter includes means for sending a tracking signal, means for activating the sending means, means for joining to a body surface and means for attaching about a body part. A GPS receiver is configurable for receiving the tracking signal from the GPS transmitter. The GPS receiver includes means for housing the GPS receiver, means for displaying a map image, means for emitting alert tones and verbal announcements, means for receiving the tracking signal from the GPS transmitter and alerting a user, means for displaying an icon identifying the GPS transmitter on the displaying means, means for displaying a name associated with the icon, means for producing verbal announcements, means for presenting available information regarding a mode of transportation associated with the GPS transmitter and means for activating the receiving means to receive the tracking signal, whereby the user can clearly identify and locate the GPS transmitter.

In another embodiment a tracking system for individuals, pets or possessions is presented. The system includes a GPS transmitter configurable for joining to individuals, pets or possessions. The GPS transmitter includes a transmitter for sending a tracking signal. When the GPS transmitter is configured for joining to individuals the transmitter includes a button for activation. An adhesive patch joined to the transmitter for adhesively attaching to a body surface is included. Means for attaching about a body part when the GPS transmitter is configured for joining about body parts of individuals or pets is included. A GPS receiver configurable for receiving the tracking signal from the GPS transmitter includes a housing for housing the GPS receiver. A map display contained within the housing for at least displays a map image. A speaker contained within the housing emits alert tones and verbal announcements. A receiver receives the tracking signal from the GPS transmitter and alerts a user with a programmable alert tone individually identifying the GPS transmitter. A programmable icon display on the map display. The programmable icon individually identifies the GPS transmitter and is superimposed on the map image to indicate the location of the GPS transmitter. A programmable name, associated with the programmable icon, displays on the map display. Means for producing verbal announcements on the speaker is included. Means for presenting available information regarding a mode of transportation associated with the GPS transmitter is included. An activation button for activating the receiver to receive the tracking signal without requiring the activation of the transmitter, whereby the user can clearly identify and locate the GPS transmitter.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide a two part tracking system comprising a transmitter and a GPS receiver/monitor. The first part, the transmitter, is preferably a small button affixed to an undetectable sticker similar to a band aid, an undetectable strap that fits around the leg, torso or arm or the transmitter can be affixed to a piece of jewelry. In preferred embodiments, the button activates the second part of the tracking system, a hand-held GPS receiver/monitor. The GPS receiver/monitor is preferably about the size of a cell phone or small tape recorder. The GPS monitor displays a travel map similar to a car GPS and is enhanced by voice support in preferred embodiments.

Preferred embodiments of the present invention may be used to track children ages three and up and younger in some instances, elderly people or adults who experience seizures, epilepsy or other disorientation issues and animals such as, but not limited to, dogs, cats, other pets, and farm animals. Preferred embodiments will not only work well only for dogs but would also work well for indoor cats and other animals that may get out or lost accidentally. Those skilled in the art, in light of the present teachings, will readily recognize that preferred embodiments of the present invention may be used to track other items such as, but not limited to, different kinds of people or animals or movable property that may be stolen, for example, without limitation, automobiles or bicycles.

Preferred embodiments of the present invention have the potential to save the lives of children, the elderly, challenged adults and animals by enabling them to set off a tracking signal via a device attached to an inconspicuous area of the body. This device sends a signal that activates a small GPS hand-held visual map monitor that aids in recovery. In preferred embodiments the GPS monitor displays and voices the path of the lost step by step and/or mile-by-mile. Preferred embodiments are different from currently known tracking systems in that they utilize a hand-held GPS monitor for recovery, do not require the wearer to leave specified boundaries before becoming active, have an extensive, not limited, coverage area, enable the GPS monitor/receiver holder to immediately take action, and utilize activation devices or transmitters that are virtually undetectable.

Preferred embodiments of the present invention can provide parents, pet owners and families with elderly or medically challenged loved ones the comfort of knowing that they are protected and that the ability to take action lies in their hands to do something to protect their loved ones before serious harm can be done to them. Preferred embodiments also provide users with the ability to alert police as to the exact whereabouts of the abducted or lost person or animal. Therefore, preferred embodiments may be a strong deterrent for those looking to kidnap children or pets.

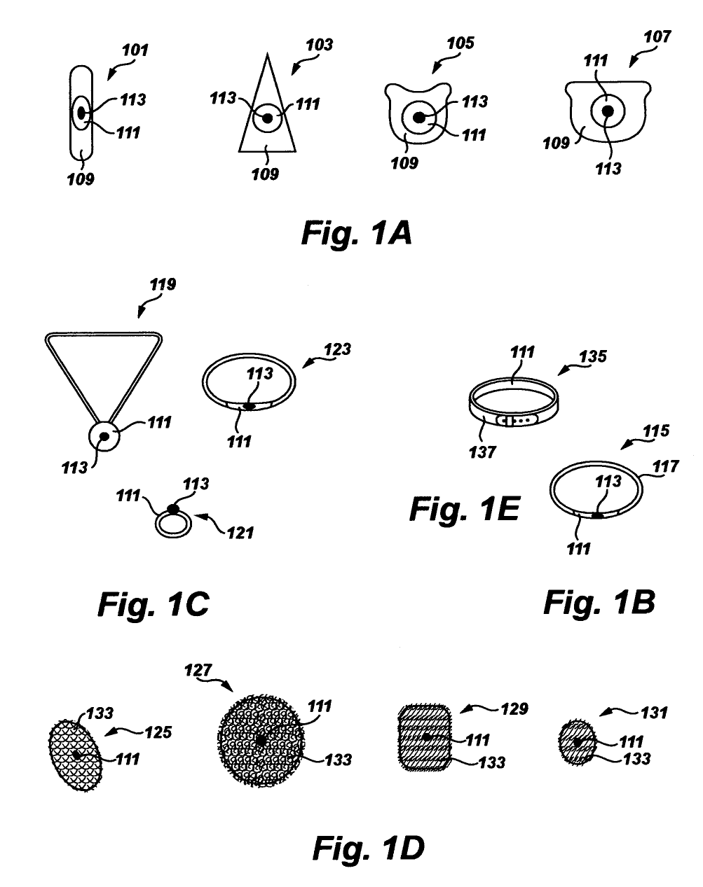

FIGS. 1A through 1E illustrate exemplary transmitters for a GPS tracking system for locating people or animals, in accordance with embodiments of the present invention. FIG. 1A shows adhesive patches 101, 103, 105, and 107; FIG. 1B shows an adhesive strap transmitter 115; FIG. 1C shows jewelry transmitters 119, 121 and 123; FIG. 1D shows adhesive patches 125, 127, 129, and 131 for animals, and FIG. 1E shows a collar transmitter 135. Referring to FIG. 1A, each adhesive patch comprises an adhesive area 109, a GPS transmitter 111 and a button 113. In typical use of the present embodiment, adhesive areas 109 of patches 101, 103, 105, and 107 are attached to a person's body similarly to a bandage. Adhesive patches 101, 103, 105, and 107 may be worn virtually anywhere on the body; however, they are preferably placed in an inconspicuous location such as, but not limited to, the back or the foot. The shapes of patches 101, 103, 105, and 107 are shown as non-limiting examples, and patches in alternate embodiments may be a multitude of different shapes such as, but not limited to, circles, squares, hearts, stars, etc. In the present embodiment, adhesive area 109 may be replaced if the adhesive is no longer sticky.

Referring to FIG. 1B, adhesive strap transmitter 115 comprises an adhesive strap 117, GPS transmitter 111 and button 113. In typical use of the present embodiment, adhesive strap 117 fits around a portion of the body such as, but not limited to, the thigh, the lower leg, the upper arm, or the torso and adheres to itself in order to remain in place. In alternate embodiments the strap may not be adhesive and may be held onto the person's body using different means such as, but not limited to, elastic, Velcro, snaps, buckles, etc.

Referring to FIG. 1C, jewelry transmitters 119, 121 and 123 each comprise GPS transmitter 111 and button 113. Jewelry transmitter 119 is a necklace with GPS transmitter 111 and button 113 incorporated into a pendant. Jewelry transmitter 121 is a ring, and jewelry transmitter 123 is a bracelet. GPS transmitters and buttons may be incorporated into various different types of jewelry such as, but not limited to, necklaces without pendants, watches, pins, etc. In typical use of the present embodiment, the preferred jewelry transmitter is worn just as a conventional piece of jewelry is worn.

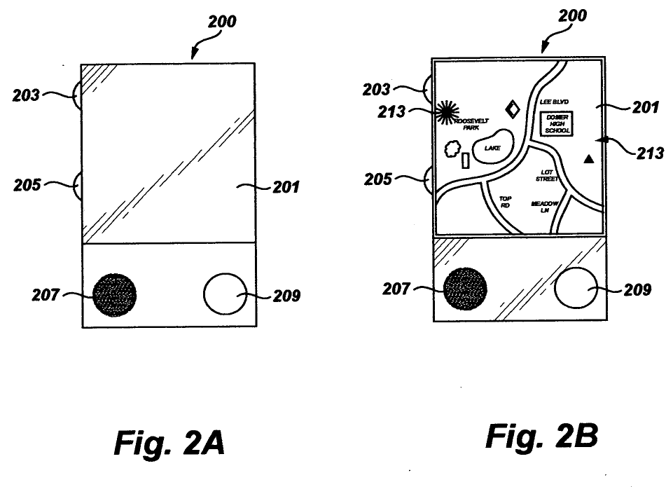

Adhesive strap transmitter 115 and jewelry transmitters 119, 121 and 123 may be more appropriate for older children or for the elderly and adults, while adhesive patches, such as, but not limited to, those illustrated by way of example in FIG. 1A, may be more appropriate for younger children. However, the type of transmitter worn by the person to be tracked may be determined by various factors including, but not limited to, preference, severity of the condition, input from family members, etc. The transmitter is preferably not worn in a visible or obvious location, especially for transmitters worn by children. This generally insures that an abductor will not remove the transmitter. Wearers of transmitters according to embodiments of the present invention would be taught when and how to activate the tracking system by pressing button 113. When a child is approached, lured, attacked, physically removed from any location, or lost, the child presses button 113 twice in succession. The tracking system according to the present embodiment is also effective for elderly individuals who suffer from disorientation or from disabling medical conditions or for adults who suffer from seizures, epilepsy or other disorientation issues. If they become disoriented or feel an attack coming on, the adult can push button 113 twice, enabling their family members to locate them. This activates a GPS receiver/monitor, as described by way of example in accordance with FIG. 2. All wearers of the present embodiment are required to press button 113 twice to generally ensure that the GPS receiver/monitor is not activated accidentally. However, in alternate embodiments, the GPS receiver/monitor may be activated by only pressing the button once or by pressing the button more than twice. The GPS receiver/monitor may also have activation means so that the parent or guardian may activate the tracking system rather than the person who is wearing the transmitter. Furthermore, the transmitter may be programmed to activate the GPS receiver/monitor if the wearer leaves specified boundaries.

Referring to FIG. 1D, adhesive patches 125, 127, 129, and 131 comprise a furry surface 133 with an adhesive backing and GPS transmitter 111. In the present embodiment, the adhesive backing would only affix to skin that has fur, and furry surface 133 would be the same color as the animal's fur to avoid detection. Adhesive patches 125, 127, 129, and 131 may be affixed to any area on the body of the animal, and these patches are replaceable in the case that the adhesive backing is no longer sticky. In the present embodiment, adhesive patches 125, 127, 129, and 131 are preferably about the size of a fifty-cent piece; however, alternate embodiments may be larger or smaller.

Referring to FIG. 1E, collar transmitter 135 comprises a typical pet collar 137 and GPS transmitter 111. Various types of collars may be used in the present embodiment. For example, without limitation, collar 137 is shown with a buckle in FIG. 1E; however, collars with different fastening means such as, but not limited to, plastic clasps, Velcro, etc. may be used, and collars may be made of various different materials including, without limitation, leather, plastic, nylon, cloth, etc. In the present embodiment, GPS transmitter 111 is adhered to the inside surface of collar 137 to avoid detection. In alternate embodiments the GPS transmitter may be on the outside of the collar or incorporated into a tag attached to the collar, similar to a typical nametag. In the present embodiment, collar transmitter 135 is worn by an animal just as a typical collar is worn.

Since animals wearing transmitters according to embodiments of the present invention cannot press a button, GPS transmitters 111 in adhesive patches 125, 127, 129, and 131 and in collar transmitter 135 may automatically activate the GPS receiver/monitor or the user of the GPS receiver/monitor may manually activate the GPS receiver/monitor. For example, without limitation, when the animal is discovered missing, its owner may push a button on the GPS receiver/monitor to activate it, or GPS transmitter 111 may be programmed to activate the GPS receiver/monitor when the animal leaves specified boundaries. For example, without limitation, GPS transmitter 111 may be programmed to notify the owner if an indoor animal ends up outside.

FIGS. 2A and 2B illustrate an exemplary GPS receiver/monitor 200 for a GPS tracking system for locating people or animals, in accordance with an embodiment of the present invention. FIG. 2A is a front view where a map display screen 201 is inactive, and FIG. 2B is a front view with map display screen 201 activated. In the present embodiment, GPS receiver/monitor 200 comprises map display screen 201, an on/off switch 203, a volume control 205, a speaker 207, and an activation button 209. Alternate embodiments may comprise various other controls such as, but not limited to, brightness controls, a mute button, scrolling arrows, etc. In the present embodiment, GPS receiver/monitor 200 is about the size of a cell phone.

In typical use of the present embodiment, when the wearer of a transmitter presses a button on the transmitter or leaves specified boundaries or the holder of GPS receiver/monitor 200 presses activation button 209, GPS receiver/monitor 200 is activated. When activated, GPS receiver/monitor 200 beeps, and the holder of GPS receiver/monitor 200 turns on GPS receiver/monitor 200 with on/off switch 203, which turns on map display screen 201 and a verbal tracking locater. Map display screen 201 displays the travel route via a visual street-by-street and turn-by-turn map similarly to a car GPS, thereby providing exact street or highway locations. In the present embodiment, GPS receiver/monitor 200 also provides as much information as technology permits regarding the description of the vehicle in which the transmitter wearer is traveling or if another mode of transportation is being used.

In the present embodiment, the verbal feature is added support in the location process; however, alternate embodiments may be implemented without a verbal feature. Some non-limiting examples of verbal narratives that may be provided by GPS receiver/monitor 200 are as follows. “Tommy is traveling north towards Meadow Lane.” “Spot is traveling south on Highland and Ogden Roads, left side of street.” “Fluffy is traveling North on left side shoulder of highway US-1. At this present time traffic is extremely heavy.” “Warning BoBo Kitty is no longer inside. She is traveling behind the house heading towards the grassy field on North and Harrison adjacent to your home.”

Map display screen 201 and the verbal tracking locator provides the parent or guardian with the exact street-by-street or highway location of the person or animal via a map as he or she is in transit; it will also provide feedback if the person or animal is immobile. If the family has more than one child or other type of transmitter wearer, GPS receiver/monitor 200 may be programmed to offer a distinguishable beep to individually identify each transmitter. Also, a different icon may be programmed for different transmitter wearers so that the locations of multiple people or animals may be easily recognized on map display screen 201. For example, without limitation, referring to FIG. 2B a child display icon 211 is different from a pet display icon 213. Icons may not only differ between people and animals, but each individual that wears a transmitter may have their own distinguishable icon. Furthermore, the name of the person or animal wearing the activated transmitter is displayed below map display screen 201. The use of a tracking system according to the present embodiment, gives a panicked parent or guardian the ability to clearly identify exactly when a child, dependant adult, or animal has been abducted or lost and where they are headed without the need to waste time contacting a command center or looking at a website for location information. This can save valuable time in the recovery of an abducted or lost child, adult or animal.

Having fully described at least one embodiment of the present invention, other equivalent or alternative methods of providing tracking means for lost or abducted people or animals according to the present invention will be apparent to those skilled in the art. The invention has been described above by way of illustration, and the specific embodiments disclosed are not intended to limit the invention to the particular forms disclosed. For example, the particular implementation of the GPS receiver/monitor may vary depending upon the particular type of use of the GPS receiver/monitor. The GPS receiver/monitors described in the foregoing were directed to hand-held implementations; however, similar techniques are to provide varying sizes of GPS receiver/monitors for different uses. For example, without limitation, a larger, television sized GPS receiver/monitor may be implemented in a home or a school. Implementations of the present invention that are not hand-held are contemplated as within the scope of the present invention. The invention is thus to cover all modifications, equivalents, and alternatives falling within the spirit and scope of the following claims.

What is claimed is:

1. A tracking system for individuals, pets or possessions, the system comprising:
a GPS transmitter configurable for joining to individuals, pets or possessions, said GPS transmitter comprising: a transmitter for sending a tracking signal, when said GPS transmitter is configured for joining to individuals said transmitter comprising a button for activation; an adhesive patch joined to said transmitter for adhesively attaching to a body surface; and means for attaching about a body part when said GPS transmitter is configured for joining about body parts of individuals or pets; and
a GPS receiver configurable for receiving said tracking signal from said GPS transmitter, said GPS receiver comprising: a housing for housing the GPS receiver; a map display contained within said housing for at least displaying a map image; a speaker contained within said housing for emitting alert tones and verbal announcements; a receiver for receiving said tracking signal from said GPS transmitter and alerting a user with a programmable alert tone individually identifying said GPS transmitter; a programmable icon for displaying on said map display, said programmable icon individually identifying said GPS transmitter and being superimposed on said map image to indicate said location of said GPS transmitter; a programmable name, associated with said programmable icon, for display on said map display; means for producing verbal announcements on said speaker; means for presenting available information regarding a mode of transportation associated with said GPS transmitter; and an activation button for activating said receiver to receive said tracking signal without requiring said activation of said transmitter, whereby said user can clearly identify and locate said GPS transmitter.

2. The system as recited in claim 1, wherein said transmitter is configurable for automatic activation to send said tracking signal when said transmitter is moved outside of a desired bounded area.

3. The system as recited in claim 1, wherein said tracking signal provides a continuously updated location of said transmitter.

4. The system as recited in claim 1, wherein when said GPS transmitter is configured for joining to body surfaces of pets, said adhesive patch comprises a furry surface generally matching a color of a fur of a pet.

5. The system as recited in claim 1, wherein when said GPS transmitter is configured for joining about body parts of individuals said means for attaching comprises jewelry to which said transmitter is joined.

6. The system as recited in claim 1, wherein when said GPS transmitter is configured for joining about body parts of pets said attaching means comprises a collar where said transmitter is joined to an interior surface of said collar to avoid detection.

7. The system as recited in claim 1, wherein said map image and a position of said programmable icon on said map image being continuously updated using said tracking signal.

8. The system as recited in claim 1, wherein said verbal announcements provide a plurality of verbal narratives associated with said location of said GPS transmitter.

9. The system as recited in claim 1, further comprising a plurality of said GPS transmitters and said GPS receiver is configured with individual alert tone, programmable icon and programmable name for each of said plurality of GPS transmitters.

10. The system as recited in claim 1, wherein said adhesive patch is replaceable.

11. A tracking system for individuals, pets or possessions, the system comprising:
a GPS transmitter configurable for joining to individuals, pets or possessions, said GPS transmitter comprising: a transmitter for sending a tracking signal, when said GPS transmitter is configured for joining to individuals said transmitter comprising a button for activation where, when an individual requires assistance, said individual presses said button a plurality of times to activate said transmitter to send said tracking signal, when said GPS transmitter is configured for joining to pets said transmitter is configurable for automatic activation to send said tracking signal when said transmitter is moved outside of a desired bounded area, said tracking signal providing a continuously updated location of said transmitter; means for joining to a body surface when said GPS transmitter is configured for joining to body surfaces of individuals or pets, said means for joining comprising an adhesive patch joined to said transmitter for adhesively attaching to said body surface, when said GPS transmitter is configured for joining to body surfaces of individuals, said adhesive patch generally being attached to an inconspicuous location of said body surface to mitigate detection and unauthorized removal, when said GPS transmitter is configured for joining to body surfaces of pets, said adhesive patch comprises a furry surface generally matching a color of a fur of a pet to which the adhesive patch is to be applied, said furry surface mitigating detection and unauthorized removal; and means for attaching about a body part when said GPS transmitter is configured for joining about body parts of individuals or pets, when said GPS transmitter is configured for joining about body parts of individuals said means for attaching comprises jewelry to which said transmitter is joined, when said GPS transmitter is configured for joining about body parts of pets said attaching means comprises a collar where said transmitter is joined to an interior surface of said collar to avoid detection; and
a GPS receiver configurable for receiving said tracking signal from said GPS transmitter, said GPS receiver comprising: a housing for housing the GPS receiver; a map display contained within said housing for at least displaying a map image; a speaker contained within said housing for emitting alert tones and verbal announcements; a receiver for receiving said tracking signal from said GPS transmitter and alerting a user with a programmable alert tone individually identifying said GPS transmitter; a programmable icon for displaying on said map display, said programmable icon individually identifying said GPS transmitter and being superimposed on said map image to indicate said location of said GPS transmitter, said map image and a position of said programmable icon on said map image being continuously updated using said tracking signal; a programmable name, associated with said programmable icon, for display on said map display to further identify said GPS transmitter; means for producing verbal announcements on said speaker, said verbal announcements providing a plurality of verbal narratives associated with said location of said GPS transmitter; means for presenting available information regarding a mode of transportation associated with said GPS transmitter; and an activation button for activating said receiver to receive said tracking signal without requiring said activation of said transmitter, whereby said user can clearly identify and locate said GPS transmitter.

12. The system as recited in claim 1, further comprising a plurality of said GPS transmitters and said GPS receiver is configured with individual alert tone, programmable icon and programmable name for each of said plurality of GPS transmitters.

13. The system as recited in claim 1, wherein said adhesive patch is replaceable.

14. A tracking system for individuals, pets or possessions, the system comprising:
a GPS transmitter configurable for joining to individuals, pets or possessions, said GPS transmitter comprising:
means for sending a tracking signal;
means for activating said sending means;
means for joining to a body surface; and
means for attaching about a body part; and
a GPS receiver configurable for receiving said tracking signal from said GPS transmitter, said GPS receiver comprising:
means for housing said GPS receiver;
means for displaying a map image;
means for emitting alert tones and verbal announcements;
means for receiving said tracking signal from said GPS transmitter and alerting a user;
means for displaying an icon identifying said GPS transmitter on said displaying means;
means for displaying a name associated with said icon;
means for producing verbal announcements;
means for presenting available information regarding a mode of transportation
associated with said GPS transmitter; and
means for activating said receiving means to receive said tracking signal, whereby said user can clearly identify and locate said GPS transmitter.

15. The system as recited in claim 14, further comprising means for receiving a plurality of tracking signals from a plurality of said GPS transmitters.
